(19) United States
(12) Patent Application Publication
(10) Pub. No.: US 2014/0244547 A1
(43) Pub. Date: Aug. 28, 2014

(54) Antimicrobial film retrofit product for high traffic sanitation

(71) Applicant: Andrew David Zawisza, Ann Arbor, MI (US)

(72) Inventor: Andrew David Zawisza, Ann Arbor, MI (US)

(21) Appl. No.: 13/781,709

(22) Filed: Feb. 28, 2013

(51) Int. Cl. G06Q 90/00

(52) U.S. Cl. CPC G06Q 90/00
USPC 705/500; 424/405; 514/789

(57) ABSTRACT

There is a widespread need for an improvement in the overall sanitation level of high traffic public and private establishments, which contain equipment that undergoes constant changing of hands by those who frequent the establishment. Currently, there is little financial incentive for such establishments to incorporate more advanced sanitation and cleaning protocols. The solution can be realized by creating an article of manufacture with antimicrobial properties and providing installation in immediately retrofit form to create financial incentives for the establishment operator/owner and companies whose products are marketed within that establishment. The invention consists of two key components that, together, satisfy a continuing technical and biological problem and provide a valuable advertising vehicle for many companies. The first component is an article of manufacture with antimicrobial properties customized to retrofit onto existing equipment to improve sanitation. The second component is a method of conception of the article of manufacture that incorporates advertising graphics and installation service.

### TECHNICAL FIELD

The disclosed invention generally relates to articles of manufacture for improving sanitation and the methods for conception of the invention in high foot traffic areas.

### BACKGROUND ART

High traffic public areas are constantly populated with people of varying degrees of cleanliness. Further, the foot traffic in such areas constantly changes, resulting in an influx and outflow of people that ultimately perpetuates circulation of unwanted microbial organisms. Many establishments and areas with high foot traffic contain equipment/devices that people use while frequenting that establishment. Consequently, the surface of interaction of such equipment constantly changes hands with little down time and as a result, cleaning protocols and services cannot contain the continual contamination of equipment. Additionally, cleaning protocols at many establishments focus on cleaning areas/items that receive minimal direct skin contact from people, and the items subject to frequent use circulate from person to person, and thus are not and cannot be cleaned after each individual use. For example, shopping carts change hands multiple times per day without being cleaned, and fitness club equipment, especially weight (dumbbell/barbell) handles are frequently being used and cleaning is neglected. This results in continual inhabitance of microbial organisms, which increases the risk for health problems.

Current attempts at mitigating contamination levels to improve sanitation, using grocery stores as an example, include disposable cart handle covers, reusable cart handle covers carried by consumers during shopping trips, and elaborate, automatic cart cleaning systems for grocery stores to install. United States Patent Application 20120274117 incorporates a film with antimicrobial properties in a grocery cart part. In fitness centers, bottles of sanitizing spray placed around the establishment by the management, reusable weight handle covers are marketed for use by gym patrons, and towels are sometimes used to provide an extra barrier between benches and the body. Similar articles with antimicrobial properties are currently being marketed as ideal for fitness centers, but the actual rate of reduction to practice is minimal.

Recently, use of antimicrobial film has been employed by health care facilities to improve sanitation. For example, many new hospitals are applying this type of protection to flooring to minimize cross-contamination and spreading of infections; however, this type of application is in the best interest of the health care facility for preventing transmission of diseases, enhancing rate of patient recovery, and decreasing possibility for accidental exposure.

Additional industrial applications of similar articles with antimicrobial properties and imaging are being marketed by the raw material manufacturers, but the actual reduction to practice is low in high traffic public areas. Therefore, currently, articles of manufacture with antimicrobial properties are not a widespread action in establishments and environments that could benefit most. This includes, but is not limited to, high traffic public areas like grocery stores, lower traffic facilities with inherently elevated levels of contaminants due to the activities performed there such as fitness clubs, and high traffic public transportation systems.

One explanation for lack of widespread use of this concept of antimicrobial material is that the companies that would benefit most from this additional protection have no or little incentive to implement such because their product/service is inelastic where patrons invariably require their products regardless of cleanliness. For many of these companies, the costs of acquiring, processing, and installing antimicrobial material in their respective facilities outweigh the perceived benefits. As a result, high traffic public areas remain highly contaminated and continue to be a contributing factor to the spreading of bacteria and germs. Consequently, there exists a need to improve the sanitation in areas prone to contamination and those with a high rate of bacterial transmission.

Currently, raw material possessing antimicrobial properties is produced at the industrial level by manufacturers such as MacDermid Autotype and Kydex Thermoplastic. The raw material manufacturers do not provide the additional processing steps and installation of the antimicrobial material for smaller, more specific applications. This coupled with the fact that most high traffic public establishments have inelastic foot traffic and customer base, provides an explanation as to why the need has not been fulfilled: there is little incentive.

### SUMMARY OF INVENTION

### Technical Problem

There is a widespread need for an improvement in the overall sanitation level of high traffic public and private establishments. Such establishments provide services and/or products where patrons use equipment, which undergoes constant changing of hands. As a result, most existing cleaning methods employed by such establishments are ineffective for long-term sanitation. Other methods, while effective, are expensive and provide little financial incentive and are therefore uncommon. Additionally, many of these more effective methods require routine maintenance and resource dedication from the facility that discourage sanitation efforts.

It is an essential and primary component for companies, large, small, publicly owned or privately owned, to promote product awareness and improve methods for reaching potential customers. All companies participate in some form of advertising, which manifests in various methods, some far more effective than others. For example, two such more effective methods include targeted and point of purchase advertising. A primary obstacle of such advertising strategies is obtaining the cooperation between the advertising company and the owner of the environment/establishment in which the advertisement would be displayed for successful implementation. For example, the agreement must specify the party responsible for dedicating the resources required to install, maintain, and monitor advertisements to ensure guarantee display of the advertisement for the lifetime outlined in the contract agreement. In many ways, the level of hassle and logistics required can be determined by one party as outweighing perceived benefits.

### Solution to Problem

The solution to the stated problem is an invention that consists of two key components that, together, can satisfy both a continuing technical and biological problem and a valuable advertising method for many companies. Current United States Patent Literature utilizing antimicrobial material for high traffic applications do not incorporate the method of conception that is a key component of the invention described in the following sections.

The first component is a retrofit antimicrobial film article of manufacture customized from its raw form using a series of process steps to improve sanitation of high traffic areas. The second component is the method of conception, which consists of a unique strategy for reduction to practice to close an important gap that currently prevents widespread use of this concept of antimicrobial technology.

A process consisting of printing, adhesive application, and customizing is used to transform the raw antimicrobial film material such that it can be retrofitted onto existing equipment. The final article of manufacture is prepared for installation such that it can be easily retrofitted in the field in a form believed to be most conducive for retrofit. The final article of manufacture contains antimicrobial properties, customized features prepared for installation, and graphic print to satisfy the purposes of sanitation improvement, the inconvenience of directly acquiring the raw materials, and brand promotion, respectively.

### SUMMARY OF INVENTION

The first component, the article of manufacture, is a customized antimicrobial film retrofit product, consists, at a minimum, of the raw antimicrobial material, the printed graphic, and the adhesive. The durability and properties of each material are guaranteed to withstand high traffic establishments for the purposes of this invention and application. Each retrofit is created per specific application; therefore, if it is determined that the best mode for reduction to practice for the specific application would include an additional processing step where the film is attached to a device prior to installation in the field, the final article of manufacture will include the additional device. This attachment retrofit device may vary per application. A series of processing steps is used to transform the raw materials into the final product retrofit.

The second component, the method of conception, is the business model used for reduction of practice of the article of manufacture. The business model, which is believed to be the best method for successful reduction to practice, can be carried out using several different, but closely related strategies. In any case, the business model fills the current gaps that prevent widespread use of this and similar concepts of antimicrobial film material. First, the business model provides the article of manufacture in a customized form such that it is immediately usable and readily available for a given functional application. Second, the business model provides the service of gathering all information necessary to determine the product shape, dimensions, and required processing to reduce the inconvenience and resource dedication that would otherwise be required by the acquiring party. Installation services can also be provided to further eliminate the said inconvenience and resource dedication. Finally, graphic application can be used as an advertisement to establish financial incentives, which currently do not exist in practice for this type of application. As a result, the method of conception creates a unique functional use for the said article of manufacture and concept of similar antimicrobial film materials in general.

### ADVANTAGEOUS EFFECTS OF INVENTION

As described in the Description of Related Art section, the primary reasons the need has not been fulfilled are lack of both a financially justifiable incentive and availability of the material in a customized retrofit form. Therefore, successful conception of invention is realized by providing the extra processing steps and creating the incentive. Use of customized antimicrobial films that can be retrofitted onto existing equipment provides the product in an immediately usable form. Additionally, the opportunity for point of purchase and targeted advertising methods provides added incentives for the facility displaying the advertisements and the advertisement company itself. This opportunity can be realized by printing graphics with brands and/or logos onto antimicrobial film, which can then be installed onto existing equipment. This would appeal to the owner/operator of the establishment in which the material is installed by increasing patron confidence in sanitation. This may also attract new customers away from their otherwise preferred facility, thereby further increasing the overall foot traffic. Additionally, the owner/operating party of the said establishment benefits from the advertisement, which promotes impulse purchases, thereby increasing overall sales. Furthermore, the method of conception aspect of this invention requires no financial or resource contribution from the company operating the display environment.

While the high-level, primary purpose for applying antimicrobial film on any product or device is always to minimize microbial spreading to promote optimal health, the environment in which the material is applied and marketing niche to which the material appeals plays an important role in creating distinct markets for similar products. Advertising is one of the primary sources of financing for goods and services available to the public and certain methods of advertising are much more effective than others by nature. Targeted advertising involves selecting a specific group of people meeting a certain criteria that makes them more likely to have a vested interest in the company or product being advertised. Point of purchase advertising involves reaching people presently in the environment in which the product being advertised is offered. For example, targeted advertising in grocery stores currently exists where food/beverage companies display brands and/or logos on equipment such as carts and baskets; however, these advertisements do not involve the concept of utilizing antimicrobial material.

There are many incentives for prospective customers (businesses to advertise their logo/name/brands on antimicrobial film) to advertise using the proposed application. One primary incentive is based on the fact that not all advertising is created equal. For some methods of advertising, such as those in magazines and flyers, effectiveness depends upon a person proactively creating exposure between themselves and the advertisement. Other methods, such as television networks and radio stations, force exposure onto a person, but effectiveness is dependent on the person remaining attentive to that station or activity. Bottleneck advertising is conceptually similar, but differs in that it targets people in public areas rather than in homes or vehicles where the person can easily distract themselves for the duration of the advertisement. While such advertisements are exposed to large numbers of people, their effectiveness depends upon the interest level, current situation, and how often the area displaying the advertisement is frequented by a given individual. Advertising on antimicrobial film is superior to the aforementioned methods exposure is created in public areas/establishments that an individual frequents on a regular basis and the ads themselves are for companies whose products are closely related to purposes/activities provided by the establishment that attract their own patrons. Therefore, there is a higher probability that the people exposed to the advertisement not only have a vested interest in the product, but are in the state of mind with heightened desire for that product because of the activities in which they are engaged.

### BRIEF DESCRIPTION OF DRAWINGS

The invention is described in connection with the following drawings. FIG. 1 and FIG. 2 show the simplest dimensional forms of the article of manufacture. FIG. 3 and FIG. 4 second two show the business model at a high level. FIG. 5 and FIG. 6 show the processing steps at a high level.

FIG. 1 shows various views of the materials and article of manufacture when prepared for application onto a cubic type of device. The drawing at the top shows an overhead view of the exposed surface of the raw antimicrobial material and (example) graphic. The second drawing is a cross-sectional view of the length as shown in the top drawing. The third (drawing at the bottom) is a 3 dimensional side view of an example of what the article of manufacture might look like when attached to a square retrofit device (ie; replacement cart handle)

FIG. 2 shows various views of the materials and article of manufacture when prepared for application onto a cylindrical type of device. The drawing at the top shows an overhead view of the exposed surface of the raw antimicrobial material and (example) graphic. The second drawing is a cross-sectional view of the length as shown in the top drawing. The third (drawing at the bottom) is a 3 dimensional side view of an example of what the article of manufacture might look like when attached to a cylindrical retrofit device (ie; dumbbell handle)

FIG. 3 is a flow chart of the method of conception involving the business model with three distinct parties and installation.

FIG. 4 is a flow chart of the method of conception involving the business model with two distinct parties and installation.

FIG. 5 is a flow chart of the processing steps without the attachment retrofit device step.

FIG. 6 is a flow chart of the processing steps with the attachment retrofit device step.

### DETAILED DESCRIPTION OF THE INVENTION

The Article of Manufacture is produced using a series of processing steps, which are known to have no detrimental effect on the antimicrobial properties of the raw material. Processing parameters and specification of shape, appearance, dimensions, specific functional application, and installation method for the said article of manufacture are defined when practicing the method of conception. There exists a wide range of potential applications for which the article of manufacture could be beneficial, and the method of conception is believed to be the best method for reduction to practice in any given application.

Testing of the processing steps specify and verify the lifetime durability, material degradation rate, and effectiveness of antimicrobial properties. Some properties by which the antimicrobial material is tested include abrasive strength, thermal, chemical, and physical resistance, and effects of being subject to various processing. Adhesive strength is tested as being effective for the lifetime purposes in high traffic environments. Testing and analysis was carried out to evaluate the effects of cutting on the antimicrobial properties and determine the expected lifetime of the graphic before initial deterioration; this testing also confirms process viability and guarantees effective lifetime. All durability specifications are provided in the Product Data Sheets and Working Instructions. Refer to “Non-Patent Literature” for detailed information on product specifications.

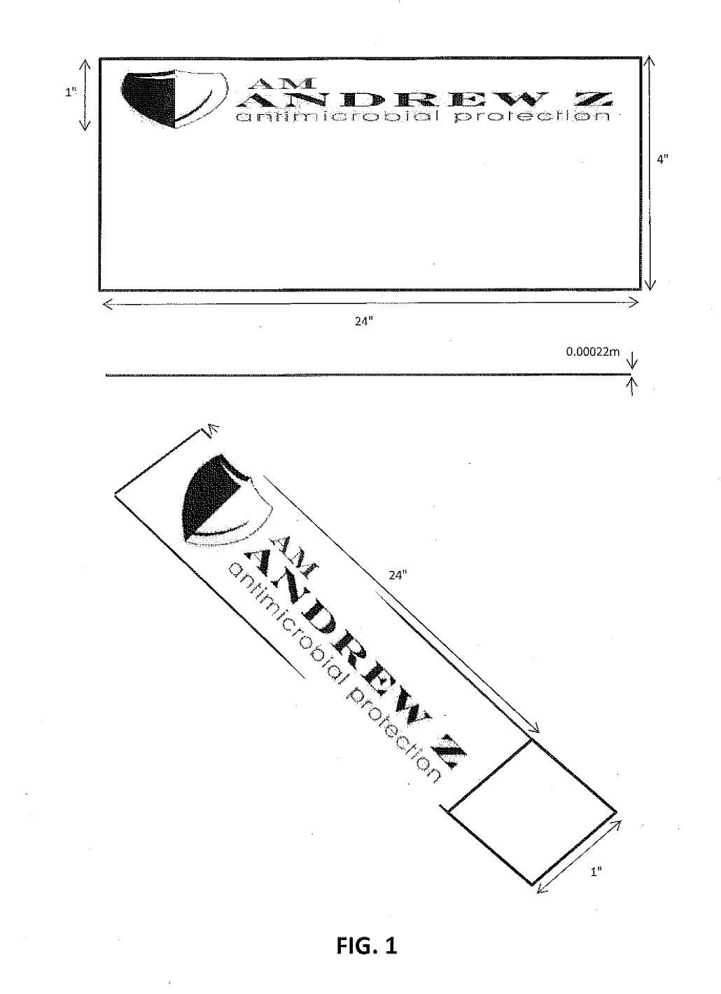

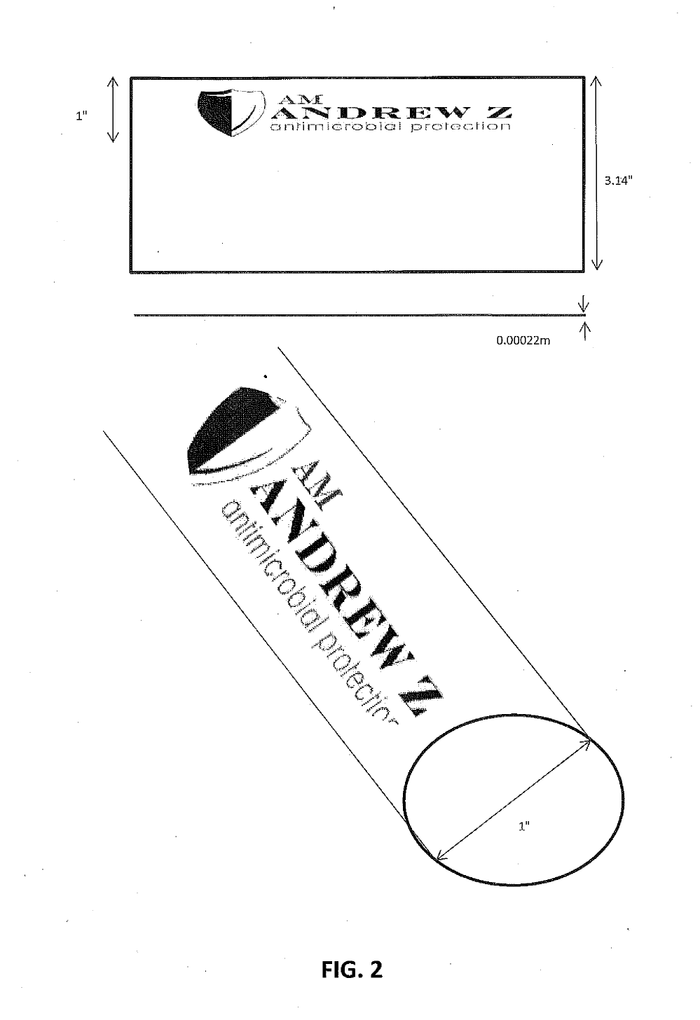

The raw antimicrobial material properties are verified to impede growth of Staphylococcus aureus (MRSA), Escherichia coli 0157, Pseudomonas aeruginosa, Salmonella enteritidis, Bacillus cereus, Streptococcus faecalis, Klebsiella pneumonia, Aspergillus niger, Penicillium purpurogenum, Phoma violacea, Saccharmyces cerevisiae, and Listeria monocytogenes. The said raw antimicrobial material is received in a form such that the second surface (underside) is primed for graphic application using reverse print ink jet processing with solvent-based ink. The primary, exposed surface (see top drawing in FIG. 1 and FIG. 2) exhibits the said antimicrobial properties. The adhesive is received as a separate composite, which consists of a pressure sensitive adhesive, an opaque polyester carrier that supports the pressure sensitive side of the adhesive during lamination, and a release liner that releases the polyester carrier from the final overlay during lamination.

The raw materials of the article of manufacture include the antimicrobial film, which is available in a standard dimension roll (Length: 50 m×1.2 m×0.00015 m) or in smaller custom cuts with the same total area as that of the standard dimension roll. The antimicrobial film incorporates Microban® antimicrobial technology. The exposed (primary) surface exhibits antimicrobial properties and the unexposed (ink primed) surface is primed for reverse printing application of the graphic.

The raw materials of the article of manufacture include the graphic image (see top drawing in FIG. 1 and FIG. 2), which can consist of a solvent-based ink, or UV curable inks/coatings, which may be comprised of liquid monomers, oligomers, and photoinitiators. The graphic image adds a maximum of approximately 0.000004 m to 0.000006 m to the article of manufacture thickness (see middle drawing in FIG. 1 and FIG. 2).

The raw materials of the article of manufacture include the adhesive backing, which consists of a clear Solvent Acrylic Adhesive (permanent pressure-sensitive adhesive) and opaque polyester backing that supports the permanent adhesive during lamination, which removes this layer using a release liner.

The raw materials of the article of manufacture may include an attachment retrofit device (see bottom drawing in FIG. 1 and FIG. 2) that is selected based on the specific application for which the article of manufacture is conceived. The specific application is dictated by the requirements determined during the corresponding practice of the method of conception. An example of when an attachment retrofit device may be used is described below in a preferred embodiment.

The processing steps used to create the article of manufacture that have been tested include cutting, printing using solvent-based ink and Ink Jet printing, UV fusion, and screen printing, and lamination using a cold laminating process with a maximum temperature of 50 degrees Celsius, a maximum pressure of 35 psi, and a minimum brake tension such that the release liner is just picked up.

The processing step that may also be used to create the article of manufacture that has not been specifically quantified in testing is application to an additional attachment retrofit device. “Retrofit” is defined as being provided in a form such that it can be installed in the field without the requirement of any further processing steps, with the exception of manual removal of the backing to expose the adhesive, or manual mechanical attachment. “Field” is defined as the environment/establishment in which the article of manufacture is ultimately installed.

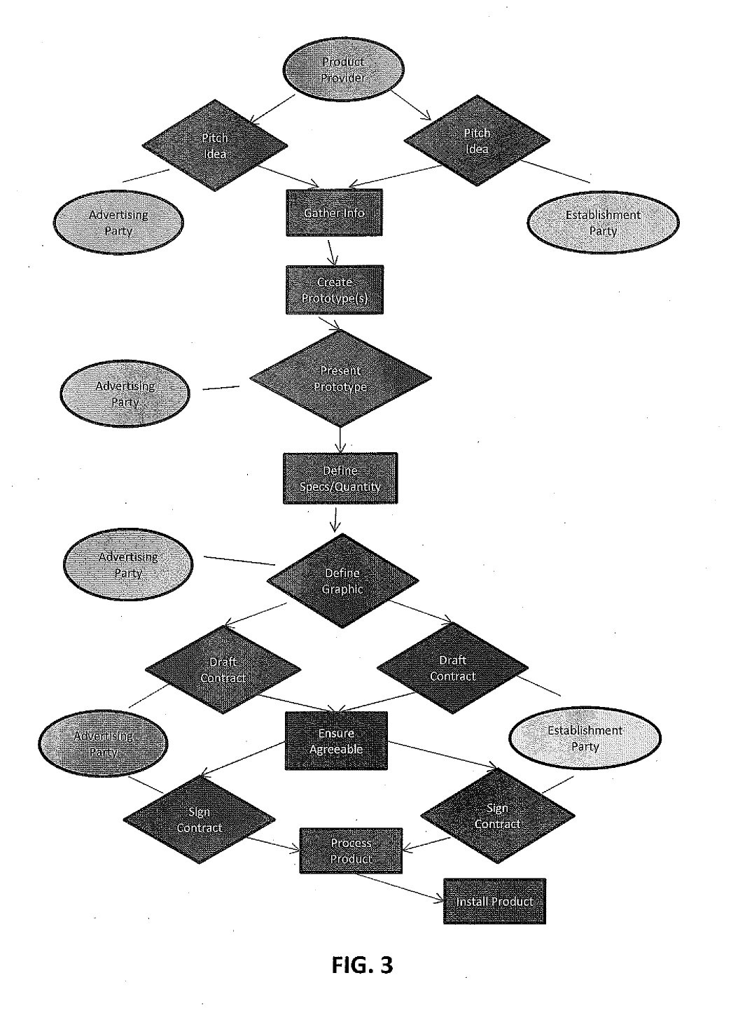

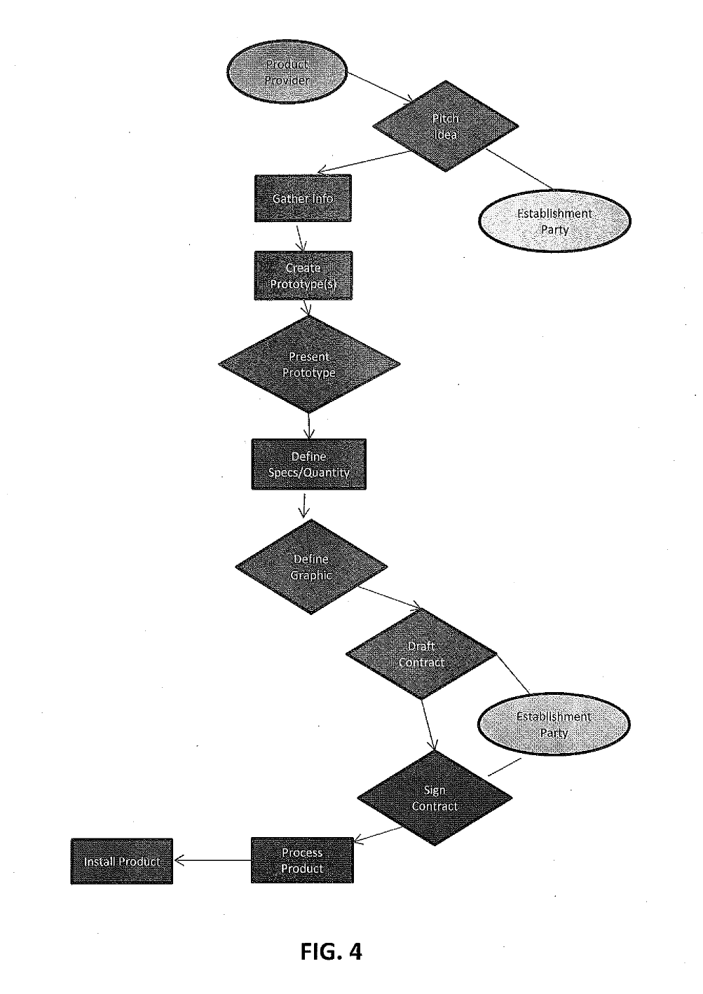

The first step to create the invention occurs prior to processing the article of manufacture and involves determination of the terms and specifications (as in “Define Specs/Quantity” in FIG. 3 and FIG. 4) required in the Method of Conception. These are determined by determining the properties of the equipment (as in “Gather Info” in FIG. 3 and FIG. 4) on which the article of manufacture is ultimately installed. A detailed description for carrying out the method of conception is included below in [0038] through [0041].

The next step is obtaining the raw materials cut to the dimensions and shape specified in the first step article of manufacture is built to order and as such, the dimensions are dependent upon the specific application, which is primarily dictated by the shape and dimensions of the equipment in the environment in which the product is installed.

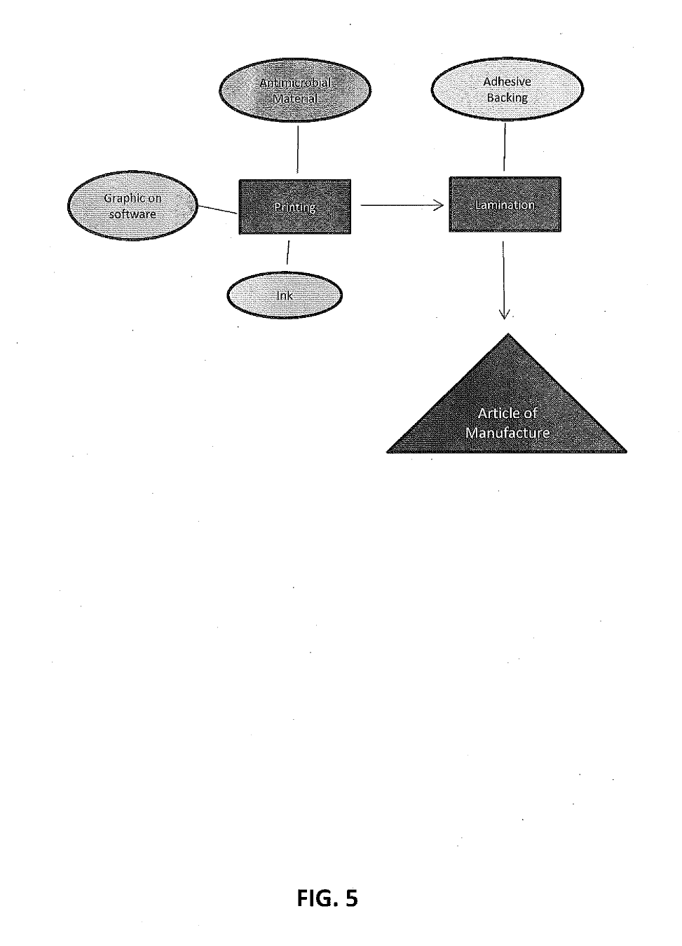

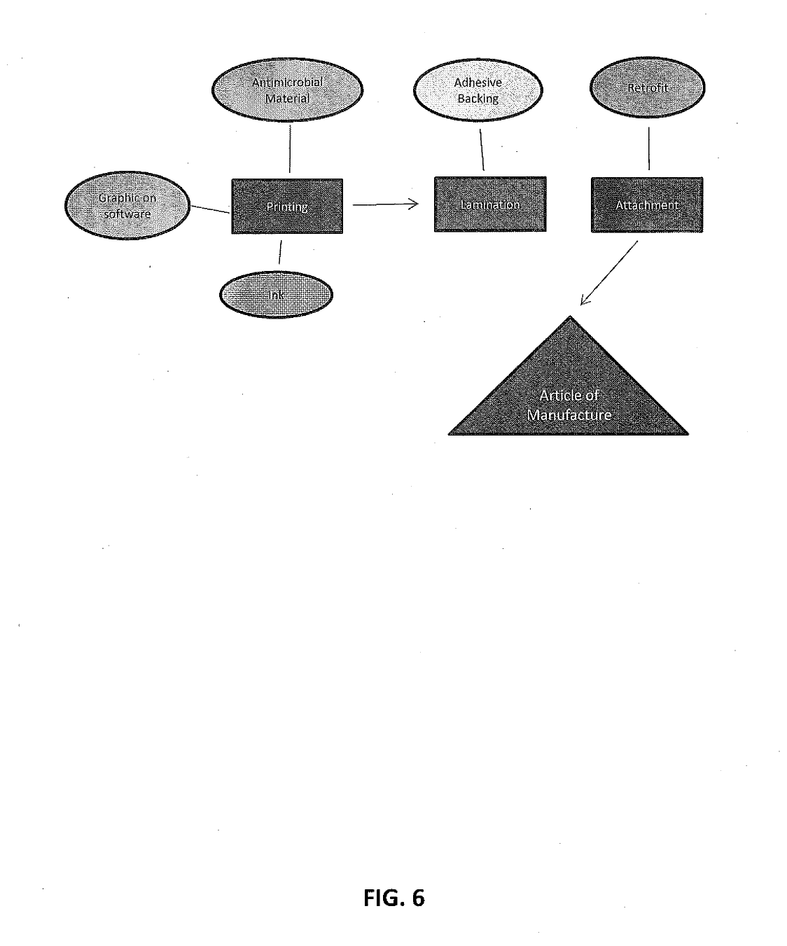

Next, the raw antimicrobial film is subject to the printing process equipment (“Printing” in FIG. 5 and FIG. 6), which incorporates graphic design computer software to apply the graphic ink in the correct location. The raw antimicrobial film is loaded onto an ink jet printer with the ink jet primed/coated side facing outward. Graphic inks are deposited on the unexposed surface (not containing the antimicrobial properties) in thin layers of approximately 4 um, which has a negligible effect on the final thickness of the overlay; the graphic inks are never deposited over 6 um. Lamination occurs at least 12 hours after the graphic is applied to ensure optimal quality and adhesion. Printing is carried out using one of several methods. The printing equipment used is either Ink Jet or UV Fusion equipment for graphic application. This optimizes quality of the graphic without compromising the raw antimicrobial material properties and effectiveness.

The third processing step is application of the adhesive, which is carried out using a cold lamination process (“Lamination” in FIG. 5 and FIG. 6). When loading the adhesive backing in the laminator, the pressure-sensitive side of the permanent adhesive that covers the image is exposed. Any heat does not exceed 60 degrees Celsius and pressure does not exceed 35 psi during lamination to prevent adverse effects on the image and material. During lamination, polyester carrier is removed using the release liner such that the final overlay is ready to be applied to the additional attachment retrofit device for optimal retrofit.

The fourth step is applying the combined raw antimicrobial material, graphic, and adhesive to the retrofit attachment device (“Attachment” in FIG. 6), if deemed appropriate for ease of installation. The fourth processing step can be carried out manually or using other methods.

The method of conception is a crucial aspect of the invention as it closes current gaps by creating the financial incentives, product, and services currently believed to be the best mode for reduction to practice. The method of conception involves a business model that can involve either two (FIG. 4) or three (FIG. 3) distinct parties depending on the application. In the case of the former, the said two distinct parties include the provider/creator of the article of manufacture and the owner(s)/operator(s) of the establishment/environment in which the article of manufacture is installed. This can arise if the incentive already exists for a party interested in obtaining the article of manufacture that outweighs any financial and/or resource requirement by that party. In the case of the latter, the three said distinct parties include and the provider/creator of the article of manufacture, the owner(s)/operator(s) of the establishment/environment in which the article of manufacture is installed, and the party with an interest in advertising on the article of manufacture. It is currently believed that the best mode for reduction to practice is to carry out the method of conception with the business model involving three distinct parties; however, the business model involving two distinct parties may be more appropriate for some applications.

The method of conception creates a unique functional use and service for the concept of an antimicrobial material. First, the unique service manifests in the inconvenience that would otherwise exist if the said owner(s)/operating management were interested in obtaining antimicrobial material directly from a manufacture is eliminated. This inconvenience consists of the requirement of dedicating the financial, management, and labor resources necessary for carrying out the said processing steps (see FIG. 5 and FIG. 6 and “Gather Info” and “Define specs/Quantity” in FIG. 3 and FIG. 4), or similar steps, needed to customize the material for installation (see “Install Product” in FIG. 3 and FIG. 4). Second, the unique functional use manifests in the graphic printed on the Article of Manufacture that consists of some form of an advertisement or promotion. This creates the important incentives for the owner(s)/operating management of the establishment in which the invention is displayed and the advertising company that promotes their brand(s)/product(s) in the said establishment. Finally, installation services can also be provided as part of the business model.

The method of conception can be achieved by establishing two contract agreements (“Sign Contract” in FIG. 3 and FIG. 4). The first contract agreement between the advertising party (“Advertising party” in FIG. 3 and FIG. 4) and supplier of the Article of Manufacture (“Product Provider” in FIG. 3 and FIG. 4) outlines the product specifications, display period, verification that the establishment company will agree to the display period, equipment applied, graphics printed, whether the graphics will be supplied by the advertiser or designed by the inventor, non-compete guarantee specifying no competition will be advertised simultaneously in the same establishment, and financial compensation. Prior to establishing this contract, the provider of the article of manufacture obtains all necessary information (see “Gather Info” and “Define specs/Quantity” in FIG. 3 and FIG. 4) for processing (FIG. 5 and FIG. 6) and application in the field. Such information can include, but is not limited to, dimensions, quantity, and type of the equipment in the field to which in the article of manufacture is applied, shape dimensions, and required processing, and environment characteristics such as type of establishment, rate of foot traffic, and demographics. Prototypes (“Create Prototype(s)” and “Present Prototype(s)” in FIG. 3 and FIG. 4) can then be created and presented to the advertising party for determining how the graphic should appear (“Define Graphic” in FIG. 3 and FIG. 4) for the advertisement. Once the graphic is determined and designed (if necessary), the processing steps in [0034] through [0036] or [0037] (FIG. 5 or FIG. 6) are carried out.

The second contract agreement between the owner(s)/operating management of the establishment (“Establishment party” in FIG. 3 and FIG. 4) and the supplier specifies the display period to be consistent with the first contract, a guarantee of no adverse effects of the retrofit product on patrons or equipment, assurance of no financial or resource obligations, and maintenance actions if situations arise.

A preferred embodiment for reduction to practice incorporates the business model involving three parties and installation, and the article of manufacture processed with the retrofit device (see bottom drawing in FIG. 1 for an example of a cubic cart handle and bottom drawing in FIG. 2 for an example of a cylindrical cart handle) for application to shopping cart handles in a high traffic retail store environment. This can be practiced by first establishing an agreement with a company or party that markets their products in that store environment where the agreement grants the company the rights to advertise/promote their brands or service on the article of manufacture via the incorporated graphic image. Then, an agreement with the retail store operating party/owner is established, which grants permission for the provider of the article of manufacture install the article of manufacture onto existing equipment within the store environment. Lastly, the article of manufacture is conceived based on the specifications outlined in the first agreement where the adhesive side of the antimicrobial material is applied to the retrofit device, a (replacement) cart handle, prior to installation.

Another preferred embodiment for reduction to practice incorporates the business model involving three parties and installation, and the article of manufacture without the retrofit device for application to equipment subject to high exposure to human skin and residue in a fitness club, gym, or workout facility. A similar method described for carrying out the invention in the first immediately preceding example is used; however, no retrofit device is obtained prior to installation. Additionally, in this embodiment, the article of manufacture may be cut to shapes for various different devices such as weight benches, dumbbell handles (see bottom drawing in FIG. 2 for an example of a cylindrical shape commonly found on dumbbell handles), barbell handles, and cardio equipment. Therefore, the raw materials would require gathering the dimensions of such equipment prior to cutting. Finally, in this preferred embodiment, size, shape, quantity, and appearance of the graphics should be carefully considered to prevent an obnoxious, aesthetically displeasing environment when installed.

### INDUSTRIAL APPLICABILITY

There exists a wide range of potential industrial applications for this invention, which, when implemented, improves the sanitation level of any device. Specifically, the invention of the final product and processes used to create it are developed to accommodate most standard equipment in most high traffic public areas. Realization of implementation is also partially dependent upon creating the incentives, financial or otherwise, for the operating establishments and/or those wishing to endorse; if created for the latter, agreeability from the former is also required. The processing methods outlined can accommodate most levels of complexity that are within the dimensions of the raw material, but characteristics of certain environments demand much more complex parameters during processing than others.

Grocery stores can have relatively simple, standard dimension equipment such as grocery cart handles. Fitness clubs are more complicated as they have equipment of varying sizes and shapes that make processing require input of different parameters for each type of equipment. Additionally, depending on the application, the raw antimicrobial material selection varies to optimize formability, which slightly compromises texture, display, and durability. Other high traffic public areas, such as subways, buses, and stadiums can also benefit; the opportunities are limitless.

### CITATION LIST

PATENT LITERATURE

| | | |
|---|---|---|
| 20120274117 | Nov. 1, 2012 | Preisler, Darius J. |
| 20060277107 | Dec. 7, 2006 | Deal, Jim; et all |
| 7,443,295 | Oct. 28^{th}, 2008 | Brice, et al. |
| 7,374,182. | May 20, 2008. | Gurley, et al. |
| 7,222,817. | May 29, 2007. | Stringer |
| 5,429,377. | Jul. 4, 1995. | Duer |
| 5,427,392. | Jun. 27, 1995. | Duer |

### Non Patent Literature

The following includes channels for reviewing information regarding MacDermid Autotype Ltd. relevant product information

SigmaGraF AM Shield Web Page Link: http://www.macdermidautotype.com/products/industiral-display-solutions/sigma-shield/sigmagraf-shield-am

Product Data Sheet
http://www.macdermidautotype.com/MacDermid/media/Resources/datasheets/SIGMAGraf-Shield-AM-PDS-English.pdg

Product Literature
http://www.macdermidautotype.com/MacDermid/media/Resources/brochures/SigmaGraF-Shield-Brochure-English.pdg

Working Instructions SigmaGraF—16281

1. An article of manufacture comprised of an antimicrobial agent evenly distributed throughout the outer exposed surface to impede growth of Staphylococcus aureus (MRSA), Escherichia coli 0157, Pseudomonas aeruginosa, Salmonella enteritidis, Bacillus cereus, Streptococcus faecalis, Klebsiella pneumonia, Aspergillus niger, Penicillium purpurogenum, Phoma violacea, Saccharmyces cerevisiae, and Listeria monocytogenes, and with customized physical properties to be retrofitted on existing equipment/devices such that no further processing is required.

2. An article of manufacture as in claim 1, wherein shape, dimensions, functional use, and appearance are customized such that the said article of manufacture can retrofit onto existing equipment/devices.

3. An article of manufacture as in claim 2 comprised of a graphic/image.

4. An article of manufacture as in claim 3, wherein the graphic is an advertisement/promotion that is specified prior to processing by a sponsoring party other than the provider of the article of manufacture.

5. An article of manufacture as in claim 3, wherein the total thickness is less than or equal to 220 microns (0.00022 meters), and with physical formability to take the shape of the existing device to which it is applied.

6. A method of conception of an article of manufacture as in claim 5, wherein appearance, shape, dimensions, and functional use are defined for a given specific application prior to processing.

7. A method of conception as in claim 6, wherein all information required to define and customize the shape, dimensions, functional use, and appearance is obtained by the provider of the article of manufacture.

8. A method of conception as in claim 6 that involves three distinct parties, which include the provider of the said article of manufacture, the owner/operator of the establishment in which the said article of manufacture is installed, and a party whose products/brands are sold/provided in the said establishment.

9. A method of conception as in claim 6, that involves two parties, which include the provider of the said article of manufacture and the owner/operator of the establishment in which the said article of manufacture is installed.

10. A method of conception as in claim 8, wherein the incorporated graphic is an advertisement for and specified by the said party whose products/brands are sold/provided in the said establishment to promote brand(s) and/or logo(s).

11. A method of conception claim 8, wherein the said owner/operator of the establishment can benefit from the graphic and antimicrobial properties through the encouragement of impulse purchases and increased customer relations as a result of improved sanitation.

12. A method of conception as in claim 8, wherein services for installation in the said owner/operator of the establishment are provided.

13. A method of conception as in claim 7, wherein installation of the article of manufacture is provided.

14. A method of conception as in claim 8, wherein the sponsoring party is a food production company and the owner/operator of the establishment is a grocery store.

15. A method of conception as in claim 14, wherein the said article of manufacture is installed on cart handles.

16. A method of conception as in claim 8, wherein the sponsoring party is a supplement or health food company and the owner/operator of the establishment is a gym/fitness club.

17. A method of conception as in claim 16, wherein the said article of manufacture is installed on dumbbell handles, weight benches, cardio equipment, and/or barbell handles.

18. A method of conception of the article of manufacture as in claim 8 where the said article of manufacture is displayed such that the graphic is visible to the consumer and the durability, effective display lifetime, and effectiveness of the antimicrobial properties when subject to the conditions of use in that environment are maintained.

19. A method of conception of the article of manufacture as in claim 8 where the said article of manufacture is displayed in a public environment that is frequently subject to a high level of foot traffic.
